(19) United States
(12) Patent Application Publication
(10) Pub. No.: US 2014/0023854 A1
(43) Pub. Date: Jan. 23, 2014

(54) SILICON DIOXIDE SOL, SURFACE TREATMENT METHOD FOR METAL SUBSTRATE USING THE SILICON DIOXIDE SOL AND ARTICLE MANUFACTURED BY THE SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: TING DING, Shenzhen (CN); DA-HUA CAO, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/721,676

(22) Filed: Dec. 20, 2012

(30) Foreign Application Priority Data
Jul. 23, 2012 (CN) 2012102545827

(51) Int. Cl. C09D 1/04

(52) U.S. Cl. CPC C09D 1/04
USPC 428/328; 106/634; 252/512; 252/514; 427/397.7; 427/123; 427/125; 428/447

(57) ABSTRACT

A silicon dioxide sol includes tetraethyl silicate, sodium silicate, dimethylformamide, absolute ethanol, hydrochloric acid and water. A surface treatment method for metal substrate using the silicon dioxide sol and articles manufactured by the method is also provided, the surface treatment providing significantly better ant-corrosion and anti-wear properties for the metal substrate.

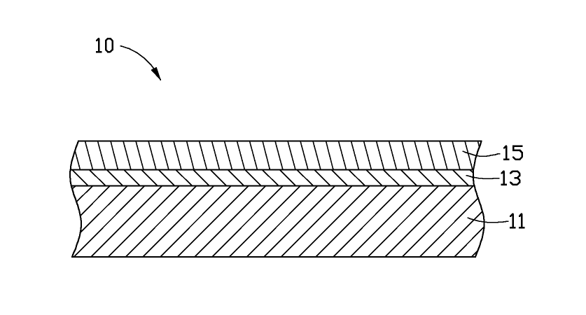

### BACKGROUND

1. Technical Field

The present disclosure relates to a silicon dioxide sol, a surface treatment method for metal substrate using the silicon dioxide sol and articles manufactured by the surface treatment method.

2. Description of Related Art

Aluminum or aluminum alloy is widely used for its excellent properties. However, aluminum and aluminum alloy are prone to corrosion because the aluminum or aluminum alloy has a very low standard electrode potential. To protect the underlying aluminum or aluminum alloy from corrosion, an insulation layer may be formed between the aluminum or aluminum alloy and a vacuum deposited protective layer for the purpose of preventing galvanic corrosion in the layers and reaching the aluminum or aluminum alloy. However, since the layers often have pinholes and cracks formed therein, the corrosive agents can permeate the layers creating a galvanic cell in the protective layer and the aluminum or aluminum alloy. The protective layer may then become a cathode of the galvanic cell and the aluminum or aluminum alloy may become an anode. When a surface area of the cathode is larger than the surface area of the anode (small portion surface of the aluminum or aluminum alloy), a large corrosive current of the galvanic cell will be created in the protective layer and the aluminum or aluminum alloy. As such, both the protective layer and the aluminum or aluminum alloy are quickly corroded.

Therefore, there is room for improvement within the art.

### BRIEF DESCRIPTION OF THE DRAWINGS

Many aspects of the embodiment can be better understood with reference to the drawing. The components in the drawing are not necessarily drawn to scale, the emphasis instead being placed upon clearly illustrating the principles of the exemplary disclosure.

The FIGURE is a schematic view of an exemplary embodiment of a coating of an article.

### DETAILED DESCRIPTION

According to an exemplary embodiment, a silicon dioxide sol substantially includes tetraethyl silicate (TEOS), sodium silicate, dimethylformamide (DMF), conductive metal powder, absolute ethanol, hydrochloric acid, and water; wherein the volume percentage of TEOS is about 40% to about 50%, the volume percentage of sodium silicate is about 5% to about 10%, the volume percentage of DMF is about 2% to about 4%,the volume percentage of conductive metal powder is about 5% to about 10%, the volume percentage of absolute ethanol is about 5% to about 10%, the volume percentage of hydrochloric acid is about 3% to about 5%, and the volume percentage of water is about 20% to about 30%. The pH value of the silicon dioxide sol is about 3 to about 5.

Hydrochloric acid acts as catalyst for providing H₃O⁺ ions to promote film formation. Hydrochloric acid can also adjust the pH value of the silicon dioxide sol.

DMF acts as complexing agent complex with intermediate which is hydrolyzed by TEOS to form a chelation, and also can reduce the polycondensation rate of the silicon dioxide sol to prevent cracking in the layer formed by silicon dioxide sol.

The conductive metal powder may be aluminium powder, antimony powder or silver powder. The conductive metal powder having nano-size particles provides improved dispersibility of the conductive metal powder and conductivity of the silicon dioxide sol. In the embodiment, the conductive metal powder has a particle size in a range of about 30 nm to about 50 nm.

The silicon dioxide sol is formed as follows:

TEOS, sodium silicate, water and DMF are mixed in absolute ethanol, and then conductive metal powder is added to the mixture. The pH value of mixture is adjusted to a range from 3 to 5 by adding hydrochloric acid. The mixture is stirred and filtered to separate out a silicon dioxide sol.

In the silicon dioxide sol, the volume percentage of TEOS is about 40% to about 50%, the volume percentage of sodium silicate is about 5% to about 10%, the volume percentage of DMF is about 2% to about 4%,the volume percentage of conductive metal powder is about 5% to about 10%, the volume percentage of absolute ethanol is about 5% to about 10%, the volume percentage of hydrochloric acid is about 3% to about 5%, and the volume percentage of water is about 20% to about 30%.

A surface treatment method for metal substrate using the silicon dioxide sol may at least include the following steps:

A metal substrate 11 is provided. The metal substrate 11 may be made of aluminum, aluminum alloy, magnesium, or magnesium alloy.

A silicon dioxide gel layer 13 is formed on the metal substrate 11 as follows:

A silicon dioxide sol layer is formed on the metal substrate by coating or by immersion; and then the silicon dioxide sol is converted to silicon dioxide gel by vacuum drying the metal substrate 11 at a temperature of about 40° C. to about 50° C. for about 10 min to about 15 min.

The silicon dioxide gel is heated to form a silicon dioxide gel layer 13 on the metal substrate 11. A furnace (not shown) is provided, and then the furnace is heated to about 100° C. to about 120° C. The metal substrate 11 is positioned in the furnace, and the internal temperature of the furnace is maintained at about 100° C. to about 120° C. for about 10 min to about 15 min. The internal temperature of the furnace is increased to a range from 250° C. to 300° C. and maintained at the temperature for about 30 min to about 50 min. The silicon dioxide gel layer 13 has a thickness of about 2 μm to 3 μm.

During the heating treatment, the silicon dioxide sol is converted to silicon dioxide gel as follows: firstly, TEOS aggregates into small grain clusters; secondly, the small grain clusters collide with each other and aggregate with each other to form bigger grain clusters; lastly, the bigger grain clusters connect with each other to form a (O—Si—O)n network structure. The water and the ethanol vaporize at the temperature of about 100° C. to about 120° C. At the temperature of about 250° C. to about 300° C., —OR groups of TEOS are oxidized to form O—Si—O groups, then the O—Si—O groups aggregate into (O—Si—O)n by polycondensation and dehydration reaction of silicon dioxide sol with the temperature increasing, adjacent (O—Si—O)n groups connect with each other to form a (O—Si—O)n network structure and a compact and continuous silicon dioxide gel layer 13 is obtained as a result.

A color layer 15 is formed on the silicon dioxide gel layer 13 by physical vapor deposition. The color layer 15 can be a layer of chromium-carbon (CrC), titanium-nitrogen-oxygen (TiNO), titanium-carbon-nitrogen (TiCN), titanium nitride (TiN), chromium-nitrogen-oxygen (CrNO), chromium-carbon-nitrogen (CrCN), or any other layers formed by physical vapor deposition.

During the forming of the color layer 15, the conductive metal powder in the silicon dioxide gel layer 13 provides an improved negative bias voltage applied to the metal substrate 11, enhancing the density of the color layer 15 and the bond between the color layer 15 and the silicon dioxide gel layer 13.

The figure shows an article including a metal substrate 11, a silicon dioxide gel layer 13 formed on the metal substrate 11 and a color layer 15 formed on the silicon dioxide gel layer 13.

The silicon dioxide gel layer 13 includes a (O—Si—O)n network structure formed by TEOS, and conductive metal powder in the (O—Si—O)n network structure. The conductive metal powder may be aluminium powder, antimony powder or silver powder.

The conductive metal powder having a nano-size particle. In the embodiment, the conductive metal powder has a particle size in a range of about 30 nm to about 50 nm.

The silicon dioxide gel layer 13 has a thickness of about 2 μm to about 3 μm.

The color layer 15 can be a layer of chromium-carbon (CrC), titanium-nitrogen-oxygen (TiNO), titanium-carbon-nitrogen (TiCN), titanium nitride (TiN), chromium-nitrogen-oxygen (CrNO), chromium-carbon-nitrogen (CrCN), or any other decorative layers formed by physical vapor deposition. Alternatively, the color layer 15 may be other functional layers formed by physical vapor deposition.

The silicon dioxide gel layer 13 formed between the metal substrate 11 and the color layer 15 prevents oxygen and electrolyte solution from diffusing to the metal substrate 11, thus improving the corrosion resistance of the article 10. Additionally, the conductive metal powder provides a secure bond between the metal substrate 11 and the color layer 15, which acts to further enhance the corrosion resistance of the article 10.

### EXAMPLE 1

A metal substrate 11 was provided. The metal substrate 11 was made of aluminum alloy.

A silicon dioxide sol was provided. In the silicon dioxide sol, the volume percentage of TEOS was about 40%, the volume percentage of sodium silicate was about 8%, the volume percentage of DMF was about 3%, the volume percentage of conductive metal powder was about 8%, the volume percentage of absolute ethanol was about 6%, the volume percentage of hydrochloric acid was about 4%, and the volume percentage of water was about 23%. The pH value of the silicon dioxide sol was about 3.5.

A silicon dioxide gel layer 13 was formed on the metal substrate 11 as follows:

A silicon dioxide sol layer was formed on the metal substrate by coating, and silicon dioxide sol was converted to silicon dioxide gel by vacuum drying the metal substrate 11 at a temperature of about 42° C. for about 12 min.

The silicon dioxide gel was heated to form a silicon dioxide gel layer 13 on the metal substrate 11. The metal substrate 11 was positioned in the furnace for about 12 min, the internal temperature of the furnace was about 100° C. Then, the internal temperature of the furnace was increased to about 260° C. and maintained at the temperature for about 35 min.

The silicon dioxide gel layer 13 has a thickness of about 2.5 μm.

The color layer 15 was formed on the silicon dioxide gel layer 13. The color layer 15 was a CrC layer.

### COMPARISON EXAMPLE

Unlike example 1, comparison example had no silicon dioxide gel layer 13 between the metal substrate 11 and the color layer 15. Except for the above difference, the remaining experimental conditions of the comparison example were the same as in example 1.

### RESULTS OF EXAMPLE 1 AND THE COMPARISON EXAMPLE

Salt spray test and wear resistance test were performed on the coatings of example 1 and the comparison example.

A salt spray test was performed on the articles formed by the example 1 and the comparison example. The salt spray test used a sodium chloride (NaCl) solution having a mass concentration of 5% at a temperature of 35° C. The test indicated that the coating of example 1 lasted more than 168 hours (h), and the coating of the comparison example lasted 120 h. Thus, the coating of example 1 had a good corrosion resistance property.

Wear resistance test was carried out as follows. The samples manufactured by the example 1 and the comparison example were tested using an “R180/530TE30” type trough vibrator made by Rosier Company. “RKS10K” type yellow cone abrasive, “RKK15P” type green pyramid abrasive, and “FC120” type detergent were held in the trough vibrator. The volume ratio of the “RKS 10K” type yellow cone abrasive and the “RKK15P” type green pyramid abrasive was 3:1. The “RKS 10K” type yellow cone abrasive and the “RKK15P” type green pyramid abrasive were made by Rosier Company.

The tests showed no peeling occurring on coatings of example 1, and showed only a few scratches on the silicon dioxide gel layer 13 and the color layer 15 of example 1. Peeling of the electrophoretic layer was found in the coatings in the comparison example. That is, the coating of article 10 of example 1 had better wear resistance than that of the article in the comparison example.

It is to be understood, however, that even through numerous characteristics and advantages of the exemplary disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A silicon dioxide sol, comprising:
tetraethyl silicate;
sodium silicate;
dimethylformamide;
absolute ethanol;
hydrochloric acid; and
water.

2. The silicon dioxide sol as claimed in claim 1, wherein in the silicon dioxide sol, the volume percentage of tetraethyl silicate is about 40% to about 50%, the volume percentage of sodium silicate is about 5% to about 10%, the volume percentage of dimethylformamide is about 2% to about 4%, the volume percentage of absolute ethanol is about 5% to about 10%, the volume percentage of hydrochloric acid is about 3% to about 5%, and the volume percentage of water is about 20% to about 30%.

3. The silicon dioxide sol as claimed in claim 1, wherein the pH value of the silicon dioxide sol is about 3 to about 5.

4. The silicon dioxide sol as claimed in claim 1, further comprising conductive metal powder.

5. The silicon dioxide sol as claimed in claim 4, wherein the conductive metal powder is aluminium powder, antimony powder or silver powder.

6. The silicon dioxide sol as claimed in claim 5, wherein the conductive metal powder has a particle size in a range of about 30 nm to about 50 nm.

7. A surface treatment method for metal substrate using the silicon dioxide sol, comprising:
providing a metal substrate;
providing a silicon dioxide sol, the silicon dioxide sol comprises tetraethyl silicate, sodium silicate, dimethylformamide, absolute ethanol, hydrochloric acid, and water;
forming a silicon dioxide sol layer on the metal substrate;
heating the silicon dioxide sol layer to form a silicon dioxide gel layer on the metal substrate, the silicon dioxide gel layer comprising a (O—Si—O)n network structure formed by tetraethyl silicate.

8. The surface treatment method as claimed in claim 7, wherein in the silicon dioxide sol, the volume percentage of tetraethyl silicate is about 40% to about 50%, the volume percentage of sodium silicate is about 5% to about 10%, the volume percentage of dimethylformamide is about 2% to about 4%, the volume percentage of absolute ethanol is about 5% to about 10%, the volume percentage of hydrochloric acid is about 3% to about 5%, and the volume percentage of water is about 20% to about 30%.

9. The surface treatment method as claimed in claim 8, wherein the pH value of the silicon dioxide sol is about 3 to about 5.

10. The surface treatment method as claimed in claim 7, wherein the silicon dioxide sol further comprises conductive metal powder.

11. The surface treatment method as claimed in claim 10, wherein the conductive metal powder is aluminium powder, antimony powder or silver powder.

12. The surface treatment method as claimed in claim 11, wherein the conductive metal powder has a particle size in a range of about 30 nm to about 50 nm.

13. The surface treatment method as claimed in claim 7, further comprising a step of forming a color layer on the silicon dioxide gel layer.

14. The surface treatment method as claimed in claim 7, wherein the silicon dioxide sol layer is heated as follows: the metal substrate is positioned in the furnace, and the internal temperature of the furnace is maintained at about 100° C. to about 120° C. for about 10 min to about 15 min, then the internal temperature of the furnace is increased to a range from 250° C. to 300° C. and maintained at the temperature for about 30 min to about 50 min.

15. A article, comprising: a metal substrate; and
a silicon dioxide gel layer formed on the metal substrate, the silicon dioxide gel layer comprising a (O—Si—O)n network structure formed by tetraethyl silicate.

16. The article as claimed in claim 15, wherein the silicon dioxide gel layer further comprises conductive metal powder.

17. The article as claimed in claim 16, wherein the conductive metal powder is aluminium powder, antimony powder or silver powder.

18. The article as claimed in claim 16, wherein the conductive metal powder has a particle size in a range of about 30 nm to about 50 nm.

19. The article as claimed in claim 15, further comprising a color layer formed on the silicon dioxide gel layer.

20. The article as claimed in claim 15, further comprising a color layer is a layer of chromium-carbon, titanium-nitrogen-oxygen, titanium-carbon-nitrogen, titanium nitride, chromium-nitrogen-oxygen, or chromium-carbon-nitrogen.
